(19) United States
(12) Patent Application Publication
(10) Pub. No.: US 2017/0079485 A1
(43) Pub. Date: Mar. 23, 2017

(54) Clipping Apparatus to Keep a Towel In-place

(71) Applicant: Deborah A. Johnson, Victoria, MN (US)

(72) Inventor: Deborah A. Johnson, Victoria, MN (US)

(21) Appl. No.: 14/954,670

(22) Filed: Nov. 30, 2015

Related U.S. Application Data
(60) Provisional application No. 62/219,755, filed on Sep. 17, 2015.

(51) Int. Cl. A47K 10/12; A44B 17/00; A45F 5/00; F16B 2/10; F16B 2/00

(52) U.S. Cl. CPC A47K 10/12; F16B 2/10; F16B 2/005; A45F 5/00; A44B 17/0041; A45F 2005/006

(57) ABSTRACT

A clipping apparatus to keep a towel in place includes an interchangeable embellishment and a towel clip. The towel clip is configured with a first stem, a second stem, and a spring loaded connector as the first stem and the second stem are tensionally connected to each other through the spring loaded connector. A user is able to open the towel clip by compressing the first stem and the second stem together. Once the towel clip is opened and positioned with a bath towel, the first stem and the second stem are released so that the towel clip is able to firmly secure the bath towel against the user's body. The interchangeable embellishment is selectively attached to a front surface of the first stem to enhance the appearance of the towel clip.

The current application claims a priority to the U.S. Provisional Patent application Ser. No. 62/219,755 filed on Sep. 17, 2015.

### FIELD OF THE INVENTION

The present invention relates generally to the field of bath accessories. More specifically, the present invention is a clipping apparatus that helps the users to keep a towel in place around their body.

### BACKGROUND OF THE INVENTION

Towel is generally used for drying or wiping the body or a surface as the towel is able to draw moisture through direct contact. Towels are available in a variety of sizes and designs, such as bath towels, beach towels, hand towels, etc. The bath towels are one of the most common type of towels as they can also be worn by the users to cover up their body. Since the bath towels are large enough to position around a person's body, the bath towels can be tightly wrapped around the user's body by tucking one end of the towel securely. However, bath towels almost always fall down or come loose since bath towels are not specifically designed to be worn by the users.

Therefore an object of the present invention to provide an apparatus that can firmly secure a bath towel against a person's body. More specifically, the present invention is a clipping apparatus that can easily and firmly secure a bath towel. The present invention provides two strong stems so that the back section of each stem allows the user to externally grasp-and-compress the present invention. Then the front section of each stem is positioned with the bath towel as the front sections clamp down with each other and hold the bath towel in place. Additionally, the front stem's back section is angled away from the user's body and the rear stem's back section so that the present invention does not injure the user's body. The present invention is also equipped with an interchangeable embellishment to selectively change the appearance of the present invention according the user's discretion.

### BRIEF DESCRIPTION OF THE DRAWINGS

FIG. 1 is a front perspective view of the present invention.

FIG. 2 is a rear perspective view of the present invention.

FIG. 3 is a perspective exploded view of the present invention.

FIG. 4 is a side exploded view of the present invention.

FIG. 5 is a front perspective view for the interchangeable embellishment of the present invention.

FIG. 6 is a rear perspective view for the interchangeable embellishment of the present invention.

FIG. 7 is a front perspective view for the towel clip of the present invention.

FIG. 8 is a rear perspective view for the towel clip of the present invention.

FIG. 9 is a side view for the towel clip of the present invention.

FIG. 10 is a side view of the present invention, showing the hole and the wrist lanyard.

### DETAIL DESCRIPTIONS OF THE INVENTION

All illustrations of the drawings are for the purpose of describing selected versions of the present invention and are not intended to limit the scope of the present invention.

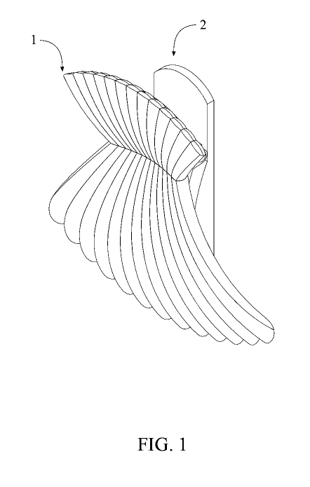

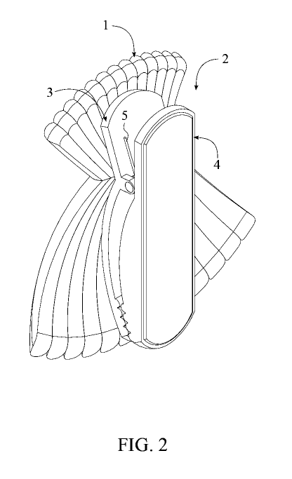

The present invention is a clipping apparatus to keep a bath towel in place. The component configuration of the present invention firmly secures a bath towel around a user's body as the present invention is able to efficiently withstand the weight of the bath towel and regular movements of the user. The present invention should also be comfortable, thus the straighter and smoothed back comes in direct contact with the user's body, typically against the woman's cleavage or man's waist, and easiest to put on and take off. The present invention comprises an interchangeable embellishment 1, a towel clip 2, and a fastening mechanism 6, wherein the towel clip 2 comprises a first stem 3, a second stem 4, and a spring loaded connector 5. In reference to FIG. 1-4, a rear surface 32 of the first stem 3 is adjacently positioned with a front surface 41 of the second stem 4 as the first stem 3 and the second stem 4 are tensionally connected to each other through the spring loaded connector 5 in order to form the towel clip 2 within the present invention. The interchangeable embellishment 1 is attached to a front surface 31 of the first stem 3 through the fastening mechanism 6 so that users are able to selectively change the appearance of the present invention through the interchangeable embellishment 1.

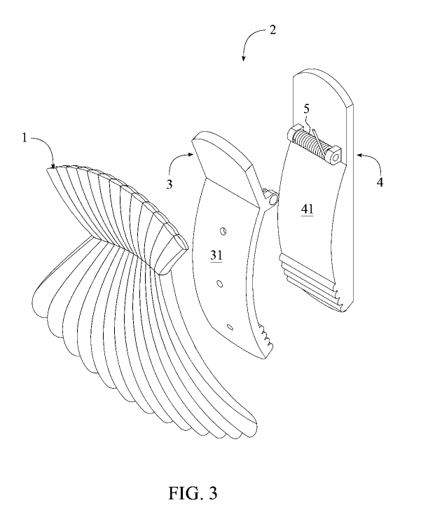

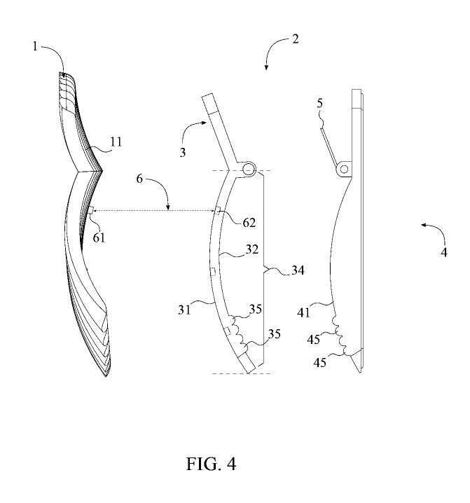

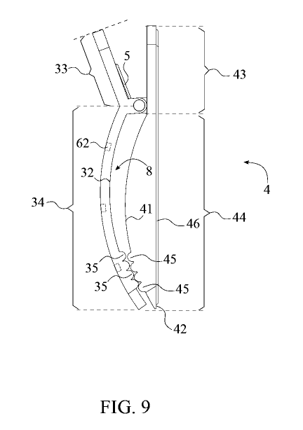

When the present invention is utilized to secure a bath towel, the first stem 3 is generally positioned away from the user's body. In reference to FIG. 3, FIG. 4, and FIG. 9, the first stem 3 comprises a first flat portion 33, a first curved portion 34, and a plurality of first ridges 35. The front surface 31 of the first stem 3 is delineated by the first flat portion 33 and the first curved portion 34. Similarly, the rear surface 32 of the first stem 3 is delineated by the first flat portion 33 and the first curved portion 34, opposite of the front surface 31 of the first stem 3. The plurality of first ridges 35 creates friction within the rear surface 32 of the first stem 3 so that the first stem 3 can be pressed against the bath towel to firmly secure the bath towel. More specifically, the plurality of first ridges 35 is adjacently positioned with a bottom end of the first stem 3 and integrated along the rear surface 32 of the first curved portion 34. The first flat portion 33 is positioned opposite of the plurality of first ridges 35 along the first curved portion 34 and adjacently connected to the first curved portion 34. This creates an obtuse angle between the first curved portion 34 and the first flat portion 33, where the obtuse angle allows the first stem 2 to compress toward the second stem 3 before the present invention is put on or taken off.

When the present invention is utilized to secure a bath towel, the second stem 4 generally positioned along the user's body. In reference to FIG. 3, FIG. 4, and FIG. 9, the second stem 4 comprises a second flat portion 43, a second curved portion 44, and a plurality of second ridges 45. The front surface 41 of the second stem 4 is delineated by the second flat portion 43 and the second curved portion 44. Similarly, a rear surface 42 of the second stem 4 is delineated by the second flat portion 43 and the second curved portion 44, opposite of the front surface 41 of the second stem 4. The plurality of second ridges 45 creates friction within the front surface 41 of the second stem 4 so that the second stem 4 can be firmly pressed against a bath towel to eliminate slippage of the bath towel. More specifically, the plurality of second ridges 45 is adjacently positioned with a bottom end of the second stem 4 and integrated along the front surface 41 of the second curved portion 44. The second flat portion 43 is oppositely positioned of the plurality of second ridges 45 along the second curved portion 44 and adjacently connected to the second curved portion 44. This creates a straight angle between the second curved portion 44 and the second flat portion 43, where the straight angle allows the first stem 2 to compress toward the second stem 3 before the present invention is put on or taken off.

The plurality of first ridges 35 and the plurality of second ridges 45 are preferably rounded and formed without any sharp edges to minimize any kind of injuries that the present invention may cause to the user or prevent any kind of damages that the present invention may cause to the bath towel. The plurality of first ridges 35 and the plurality of second ridges 45 each preferably comprises four ridges to securely grip the bath towel. However, the number of ridges are not limited to four ridges and can be any number of ridges to accommodate bath towels of different weight.

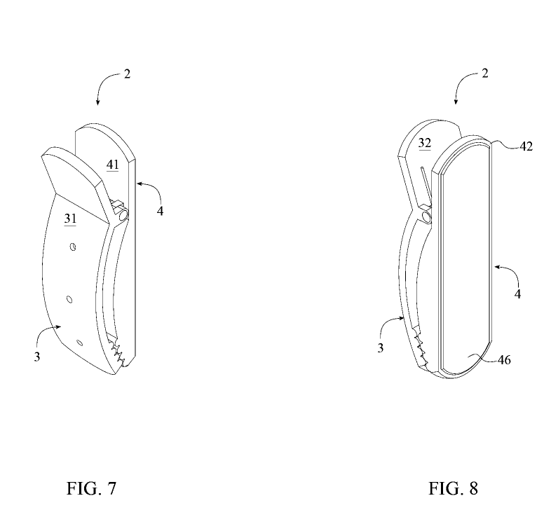

When the first stem 3 and the second stem 4 are tensionally connected to each through the spring loaded connector 5, the towel clip 2 is arranged to be in an uncompressed-configuration. In reference to FIG. 7-9, the first flat portion 33 is angularly positioned, preferably an acute angle, with the second flat portion 43 forming an empty space between the first flat portion 33 and the second flat portion 43. The uncompressed-configuration pushes the first stem 3 towards the second stem 4 such that the plurality of first ridges 35 rests on the plurality of second ridges 45, providing sufficient strength to keep the bath towel in place. The empty space between the first flat portion 33 and the second flat portion 43 allows the user to compress the first flat portion 33 and the second flat portion 43 together. As a result, the towel clip 2 can be transformed from the uncompressed-configuration to a compressed-configuration, thus opening the first stem 3 and the second stem 4 prior to using with the bath towel.

Since the rear surface 42 of the second stem 4, a flat rear surface, positioned against the user's body and the first flat portion 33 is angled away from the user's body, the present invention does not injure the user while being utilized with a bath towel. The first curved portion 34 is adjacently positioned with the second curved portion 44 such that the first curved portion 34 and the second curved portion 44 are concentrically aligned with each other. Additionally, the plurality of first ridges 35 and the plurality of second ridges 45 are pressed against each other at the bottom end of the first stem 3 and the second stem 4. A gap 8 is formed within the towel clip 2, as a result of the positioning of the plurality of first ridges 35, the rear surface 32 of the first curved portion 34, the spring loaded connector 5, the front surface 41 of the second curved portion 44, and the plurality of second ridges 45. The gap 8 allows the present invention to hold the bath towel and provides sufficient spacing for the thickness of the bath towel. Additionally, the first curved portion 34 and the second curved portion 44 provide friction upon the bath towel to reduce slippage due to the weight of the bath towel.

In reference to FIG. 8-9, the second stem 4 further comprises a layer of soft material 46. The layer of soft material 46 is preferably composed of natural, nontoxic, hypoallergenic, and antimicrobial material and connected along the rear surface 42 of the second stem 4. The positioning of the layer of soft material 46 in relation to the present invention provides a comfortable and smooth surface against the user's body, typically in the woman's cleavage or man's waist, when the present invention is utilized with a bath towel.

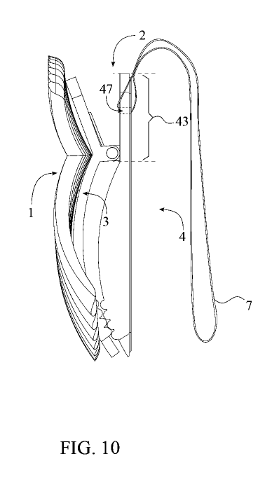

In reference to FIG. 10, the present invention further comprises a wrist lanyard 7 which allows the user to easily hold and/or carry or hang on a hook to store the present invention. The second stem 4 further comprises a hole 47 through which the wrist lanyard 7 is tethered into. More specifically, the hole 47 traverses through the second flat portion 43 so that the wrist lanyard 7 can be looped through the hole 47. The hole 47 is preferably positioned central to the second flat portion 43; however, the hole 47 can be positioned anywhere within the second flat portion 43 as long as the wrist lanyard 7 is able to be looped through the hole 47. As a result of the wrist lanyard 7, the present invention can be worn around the user's wrist making the present invention available to the user all the time, without misplacing the towel clip 2 when not in use in combination with a bath towel.

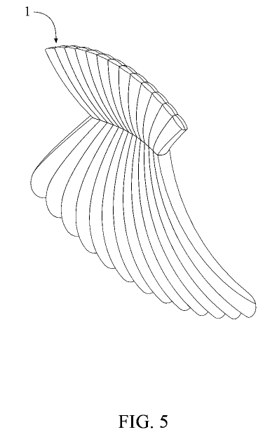

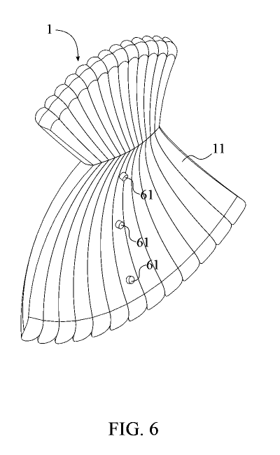

The interchangeable embellishment 1 have the capacity for several different artistic embellishments, such as sea shell designs, flower designs, geometric designs, organic designs, and company symbols. In reference to FIG. 4-6, the fastening mechanism 6 comprises at least one male fastener 61 and at least one female fastener 62 to secure the interchangeable embellishment 1. More specifically, the male fastener 61 is adjacently integrated onto a rear surface 11 of the interchangeable embellishment 1 while the female fastener 62 traverses into the first curved portion 34 from the front surface 31 of the first stem 3. Therefore, the interchangeable embellishment 1 can be selectively engaged with the towel clip 2 as the male fastener 61 engages with the female fastener 62. Even though the present invention preferably uses the male fastener 61 and the female fastener 62 to secure the interchangeable embellishment 1, the present invention can utilize any other type of fastening mechanisms 6 including, but limited to, magnetic fasteners, interlocking fasteners, and mechanical fasteners.

Although the invention has been explained in relation to its preferred embodiment, it is to be understood that many other possible modifications and variations can be made without departing from the spirit and scope of the invention as hereinafter claimed.

What is claimed is:

1. A clipping apparatus to keep a towel in place comprises:
an interchangeable embellishment;
a towel clip;
a fastening mechanism;
the towel clip comprises a first stem, a second stem, and a spring loaded connector;
a rear surface of the first stem being adjacently positioned with a front surface of the second stem;
the first stem and the second stem being tensionally connected to each other through the spring loaded connector; and
the interchangeable embellishment being attached to a front surface of the first stem through the fastening mechanism.

2. The clipping apparatus to keep a towel in place as claimed in claim 1 comprises;
the first stem comprises a first flat portion, a first curved portion, and a plurality of first ridges;
the front surface of the first stem being delineated by the first flat portion and the first curved portion;
the rear surface of the first stem being delineated by the first flat portion and the first curved portion, opposite of the front surface of the first stem;
the plurality of first ridges being integrated along the rear surface of the first curved portion;
the first flat portion being oppositely positioned of the plurality of first ridges along the first curved portion; and
the first flat portion being adjacently connected to the first curved portion.

3. The clipping apparatus to keep a towel in place as claimed in claim 1 comprises;
the second stem comprises a second flat portion, a second curved portion, and a plurality of second ridges;
the front surface of the second stem being delineated by the second flat portion and the second curved portion;
a rear surface of the second stem being delineated by the second flat portion and the second curved portion, opposite of the front surface of the second stem;
the plurality of second ridges being integrated along the front surface of the second curved portion;
the second flat portion being oppositely positioned of the plurality of second ridges along the second curved portion; and
the second flat portion being adjacently connected to the second curved portion.

4. The clipping apparatus to keep a towel in place as claimed in claim 1 comprises;
the first stem comprises a first flat portion, a first curved portion, and a plurality of first ridges;
the second stem comprises a second flat portion, a second curved portion, and a plurality of second ridges;
the first flat portion being angularly positioned with the second flat portion;
the first curved portion being adjacently positioned with the second curved portion;
the plurality of first ridges being pressed against the plurality of second ridges; and
a gap being delineated within the plurality of first ridges, the rear surface of the first curved portion, the spring loaded connector, the front surface of the second curved portion, and the plurality of second ridges.

5. The clipping apparatus to keep a towel in place as claimed in claim 1 comprises;
the second stem comprises a layer of soft material; and
the layer of soft material being connected along a rear surface of the second stem.

6. The clipping apparatus to keep a towel in place as claimed in claim 1 comprises;
a wrist lanyard;
the second stem comprises a hole;
the hole traversing through a second flat portion of the second stem; and
the wrist lanyard being looped through the hole.

7. The clipping apparatus to keep a towel in place as claimed in claim 1 comprises;
the fastening mechanism comprises at least one male fastener and at least one female fastener;
the male fastener being adjacently integrated onto a rear surface of the interchangeable embellishment;
the female fastener traversing into the first curved portion from the front surface of the first stem; and
the male fastener being engaged with the female fastener to selectively secure the interchangeable embellishment.

8. A clipping apparatus to keep a towel in place comprises:
an interchangeable embellishment;
a towel clip;
a fastening mechanism;
the towel clip comprises a first stem, a second stem, and a spring loaded connector;
the first stem comprises a first flat portion and a first curved portion;
a front surface of the first stem being delineated by the first flat portion and the first curved portion;
a rear surface of the first stem being delineated by the first flat portion and the first curved portion, opposite of the front surface of the first stem;
the second stem comprises a second flat portion and a second curved portion;
a front surface of the second stem being delineated by the second flat portion and the second curved portion;
a rear surface of the second stem being delineated by the second flat portion and the second curved portion, opposite of the front surface of the second stem;
the rear surface of the first stem being adjacently positioned with the front surface of the second stem;
the first stem and the second stem being tensionally connected to each other through the spring loaded connector; and
the interchangeable embellishment being attached to the front surface of the first stem through the fastening mechanism.

9. The clipping apparatus to keep a towel in place as claimed in claim 8 comprises;
the first stem further comprises a plurality of first ridges;
the plurality of first ridges being integrated along the rear surface of the first curved portion;
the first flat portion being oppositely positioned of the plurality of first ridges along the first curved portion; and
the first flat portion being adjacently connected to the first curved portion.

10. The clipping apparatus to keep a towel in place as claimed in claim 8 comprises;
the second stem further comprises a plurality of second ridges;
the plurality of second ridges being integrated along the front surface of the second curved portion;
the second flat portion being oppositely positioned of the plurality of second ridges along the second curved portion; and
the second flat portion being adjacently connected to the second curved portion.

11. The clipping apparatus to keep a towel in place as claimed in claim 8 comprises;
the first stem comprises a plurality of first ridges;
the second stem comprises a plurality of second ridges;
the first flat portion being angularly positioned with the second flat portion;
the first curved portion being adjacently positioned with the second curved portion;
the plurality of first ridges being pressed against the plurality of second ridges; and
a gap being delineated within the plurality of first ridges, the rear surface of the first curved portion, the spring loaded connector, the front surface of the second curved portion, and the plurality of second ridges.

12. The clipping apparatus to keep a towel in place as claimed in claim 8 comprises;
the second stem comprises a layer of soft material; and
the layer of soft material being connected along the rear surface of the second stem.

13. The clipping apparatus to keep a towel in place as claimed in claim 8 comprises;
a wrist lanyard;
the second stem comprises a hole;
the hole traversing through a second flat portion of the second stem; and
the wrist lanyard being looped through the hole.

14. The clipping apparatus to keep a towel in place as claimed in claim 8 comprises;
the fastening mechanism comprises at least one male fastener and at least one female fastener;
the male fastener being adjacently integrated onto a rear surface of the interchangeable embellishment;
the female fastener traversing into the first curved portion from the front surface of the first stem; and
the male fastener being engaged with the female fastener to selectively secure the interchangeable embellishment.

15. A clipping apparatus to keep a towel in place comprises:
an interchangeable embellishment;
a towel clip;
a fastening mechanism;
a wrist lanyard;
the towel clip comprises a first stem, a second stem, and a spring loaded connector;
the second stem comprises a hole;
a rear surface of the first stem being adjacently positioned with a front surface of the second stem;
the first stem and the second stem being tensionally connected to each other through the spring loaded connector;
the interchangeable embellishment being attached to a front surface of the first stem through the fastening mechanism;
the hole traversing through a second flat portion of the second stem; and
the wrist lanyard being looped through the hole.

16. The clipping apparatus to keep a towel in place as claimed in claim 15 comprises;
the first stem comprises a first flat portion, a first curved portion, and a plurality of first ridges;
the front surface of the first stem being delineated by the first flat portion and the first curved portion;
the rear surface of the first stem being delineated by the first flat portion and the first curved portion, opposite of the front surface of the first stem;
the plurality of first ridges being integrated along the rear surface of the first curved portion;
the first flat portion being oppositely positioned of the plurality of first ridges along the first curved portion; and
the first flat portion being adjacently connected to the first curved portion.

17. The clipping apparatus to keep a towel in place as claimed in claim 15 comprises;
the second stem comprises a second flat portion, a second curved portion, and a plurality of second ridges;
the front surface of the second stem being delineated by the second flat portion and the second curved portion;
a rear surface of the second stem being delineated by the second flat portion and the second curved portion, opposite of the front surface of the second stem;
the plurality of second ridges being integrated along the front surface of the second curved portion;
the second flat portion being oppositely positioned of the plurality of second ridges along the second curved portion; and
the second flat portion being adjacently connected to the second curved portion.

18. The clipping apparatus to keep a towel in place as claimed in claim 15 comprises;
the first stem comprises a first flat portion, a first curved portion, and a plurality of first ridges;
the second stem comprises a second flat portion, a second curved portion, and a plurality of second ridges;
the first flat portion being angularly positioned with the second flat portion;
the first curved portion being adjacently positioned with the second curved portion;
the plurality of first ridges being pressed against the plurality of second ridges; and
a gap being delineated within the plurality of first ridges, the rear surface of the first curved portion, the spring loaded connector, the front surface of the second curved portion, and the plurality of second ridges.

19. The clipping apparatus to keep a towel in place as claimed in claim 15 comprises;
the second stem comprises a layer of soft material; and
the layer of soft material being connected along a rear surface of the second stem.

20. The clipping apparatus to keep a towel in place as claimed in claim 15 comprises;
the fastening mechanism comprises at least one male fastener and at least one female fastener;
the male fastener being adjacently integrated onto a rear surface of the interchangeable embellishment;
the female fastener traversing into the first curved portion from the front surface of the first stem; and
the male fastener being engaged with the female fastener to selectively secure the interchangeable embellishment.
